(19) United States
(12) Patent Application Publication
(10) Pub. No.: US 2020/0258049 A1
(43) Pub. Date: Aug. 13, 2020

(54) Incentives Based Management of Mobile Device Usage

(71) Applicant: Matt FORBUSH, Memphis, TN (US)

(72) Inventor: Matt FORBUSH, Memphis, TN (US)

(73) Assignee: Zignyl IP, LLC, Memphis, TN (US)

(21) Appl. No.: 16/786,122

(22) Filed: Feb. 10, 2020

Related U.S. Application Data
(60) Provisional application No. 62/804,134, filed on Feb. 11, 2019.

(51) Int. Cl. G06Q 10/10; G06Q 40/00; G06F 3/0482; H04W 4/021; H04L 29/08

(52) U.S. Cl. CPC G06Q 10/1091; G06Q 40/125; H04L 67/12; H04W 4/021; G06F 3/0482

(57) ABSTRACT

A system and method for incentivizing a user including registering a mobile device of a user with a server; clocking-in, with an application on the mobile device, the user at the server; limiting a functionality of the mobile device with the application; and incentivizing the user with a benefit while the limiting of the functionality of the mobile device is in effect.

### CROSS-REFERENCE TO RELATED APPLICATIONS AND INCORPORATION BY REFERENCE

The present application claims the benefit under 35 U.S.C. 119(e) of U.S. Provisional Application Ser. No. 62/804,134, filed Feb. 11, 2019, which is incorporated herein by reference in its entirety.

### FIELD

The present teachings disclose a system and method to incentivize a user to lock or limit the functionality of a personal mobile device when running a timecard application on a mobile device, for example, while clocked in. The present disclosure teaches changing an hourly rate, a bonus, benefits or the like available to the employee based on limiting the use of personal devices on the job.

### BACKGROUND

Mobile devices (e.g., smart phones and tablets) are ubiquitous and have introduced both significant advances in communications modalities and flexibility. Mobile devices also have unintended and unforeseen side effects, primarily in the form of user distraction. Such side effects can have significant business and safety impacts. In many circumstances, it is desirable for a mobile device user to have partially or fully restricted access to features or applications on the mobile device. Although mobile device users can configure the device for restricted operation (e.g., flight or airplane mode) upon request, such requests rely on altruistic tendencies of the mobile device user. As a result, user compliance with such requests varies considerably. Increasing compliance ideally requires a means to customize and manage configuration of the mobile device for circumstances that require restricted operation, and further to provide a positive incentive, such as a monetary reward, to the mobile device user for enabling restricted operation of the device.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

The present teachings disclose a mobile device that combines configurations for restricted operating modes with an incentives model to maximize voluntary compliance, for example, with safety, business, legal or the like rules by a mobile device user.

The present teachings disclose a system and method to incentivize a user to lock or limit the functionality of a personal mobile device when running a timecard application on a mobile device, for example, while clocked in. The present disclosure teaches changing an hourly rate, a bonus, benefits or the like available to the employee based on limiting the use of personal devices on the job.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for incentivizing a user. The method includes registering a mobile device of a user with a server; clocking-in, with an application on the mobile device, the user at the server; limiting a functionality of the mobile device with the application; and incentivizing the user with a benefit while the limiting of the functionality of the mobile device is in effect. Other embodiments of this aspect include corresponding computer systems, apparatus, and computer programs recorded on one or more computer storage devices, each configured to perform the actions of the methods.

Implementations may include one or more of the following features. The method where the application may include a timecard application and the server may include a timecard server. The method may include stopping the incentivizing when the limiting of the functionality of the mobile device is not in effect. The method may include triggering the incentivizing based on the mobile device entering a geo-fenced area; and stopping the incentivizing when the mobile device leaves the geo-fenced area. The method may include triggering the limiting based on a time of day. The benefit may include changing an hourly rate of the user. The benefit may include a monetary reward for the user. The benefit may include accelerating a rate of the benefit based on a duration of the limiting. The method may include interacting with the user using a user interface prior to the limiting. The method may include receiving a configuration from the server. The method where the limiting of the functionality is selected from one or more of fully blocking execution of the user application name, partially blocking execution of the user application name, allowing execution of the user application name, allowing execution of applications on the mobile device other than the user application name, or blocking execution of applications on the mobile device other than the user application name. The method where the limiting of the functionality is selected from one or more of fully blocking use of the mobile device feature, partially blocking use of the mobile device feature, allowing use of the mobile device feature, allowing use of mobile device features on the mobile device other than the mobile device feature, or blocking use of the mobile device features on the mobile device other than the mobile device feature. Implementations of the described techniques may include hardware, a method or process, or computer software on a computer-accessible medium.

One general aspect includes a system to incentivize a user. The system includes a server to registering a mobile device of a user; an application on the mobile device to clock-in the user at the server and to limit a functionality of the mobile device with the application, where the user is incentivized with a benefit while the application limits the functionality of the mobile device. Other embodiments of this aspect include corresponding computer systems, apparatus, and computer programs recorded on one or more computer storage devices, each configured to perform the actions of the methods.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates an exemplary state diagram for a mobile device according to various embodiments.

FIG. 2 illustrates an exemplary state diagram for a mobile device according to various embodiments.

FIG. 3 illustrates an exemplary graphics user interface (GUI) to enter restricted mode on a mobile device.

FIG. 4 illustrates an exemplary GUI displaying a status indicating entrance into a restricted mode on a mobile device.

FIG. 5 illustrates an exemplary GUI displaying incentives earned in a current session of a restricted mode on a mobile device.

FIG. 6 illustrates an exemplary Create User GUI on a timecard server.

FIG. 7 illustrates an exemplary User Configuration Data GUI on a timecard server.

FIG. 8 illustrates an exemplary User Incentive Earnings Log GUI on a timecard server.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

The present teachings may be implemented using a timecard server connected via a network to a mobile device running a timecard application. The network may be a wireless network, for example, a WIFI network, a cellular network, a satellite network or the like.

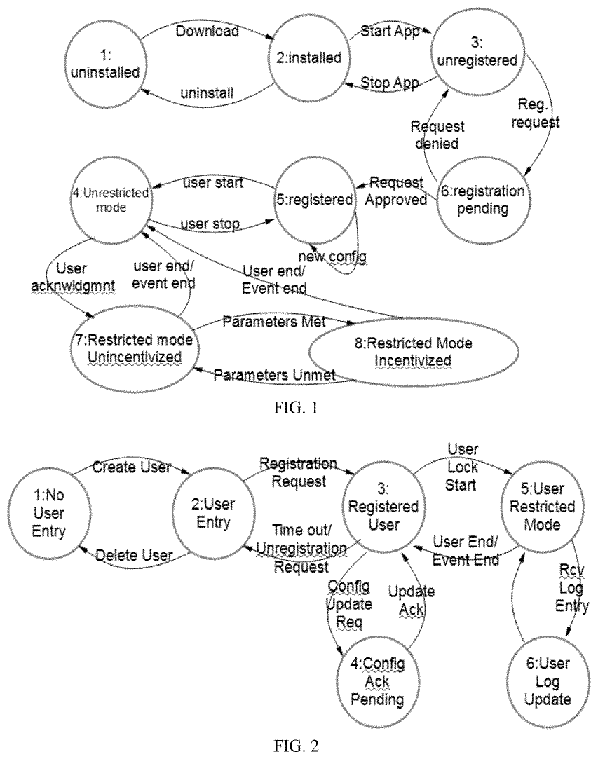

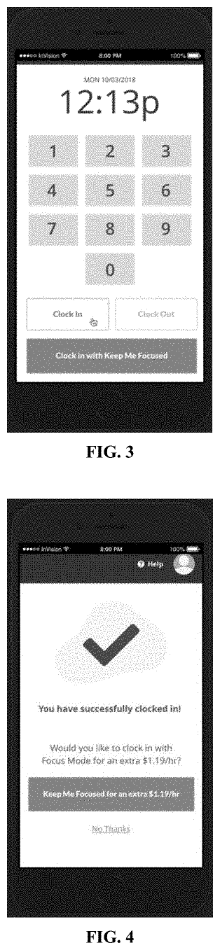

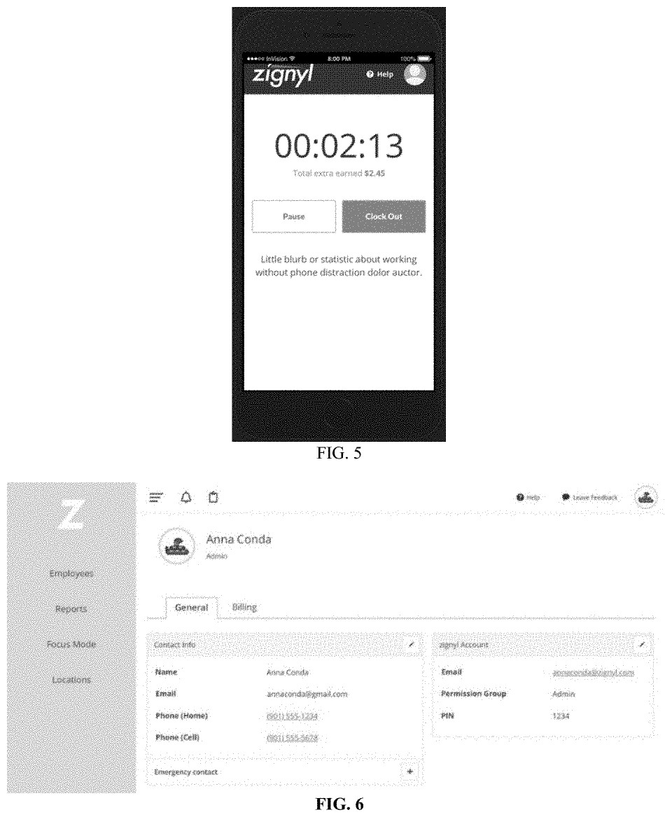

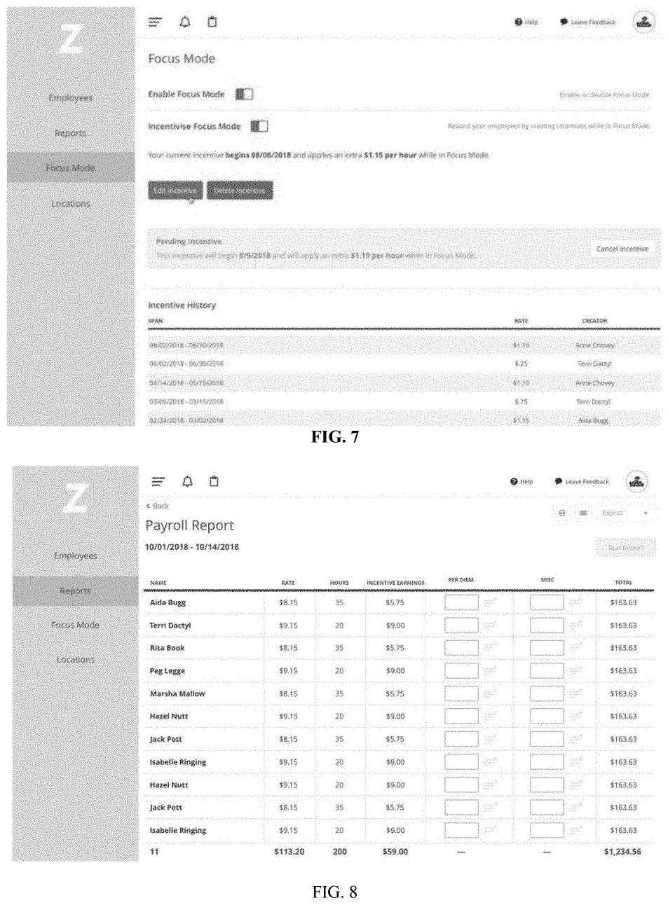

FIG. 1 illustrates an exemplary state diagram for a mobile device according to various embodiments.

### State: Uninstalled

The Timecard Application is not installed on the mobile device. No configuration files or other data associated with the application are present. When a download and install transition is initiated, the application is downloaded and installed from an online application store, from a local direct connection or other suitable source. Failure to have a successful download or install results in remaining in the uninstalled state. Successful download and install results in state change to Installed. All other events have no change in state.

### State: Installed

The Timecard Application is correctly installed on the mobile device. It is not currently connected to the Timecard server or running on the mobile device. When a Start Timecard Application transition is initiated, the application is loaded and executed by the mobile device operating system (e.g. Android, iOS, or similar). An application error during loading or starting results in remaining in the Installed state. Successful loading and starting results in state change to Unregistered. When a Uninstall Application transition is initiated, the application is uninstalled, and all related data files are deleted from the mobile device. All other events have no change in state.

### State: Unregistered

The Timecard Application is running on the mobile device but is not connected to the Timecard server. When a Send Registration Request transition is initiated on user input, the Timecard Application sends a registration request message to the Timecard server over a network connection (for example, cellular, Wi-Fi, or wired). The registration request may include user identification information. If the application receives a local failure to send error, an appropriate error dialog is displayed, and the resulting state remains unregistered. Otherwise results in state change to Registration Pending. When a Uninstall Application transition is initiated, the application is uninstalled, and all related data files are deleted from the mobile device.

### State: Registration Pending

The Timecard Application is waiting for a response from the Timecard server accepting the registration request. When a Timeout transition is initiated, the Timecard application received a timer expiration event while waiting for a registration response from the Timecard server. An error dialog may be displayed and results in a state change to Unregistered. When a Registration Request Approved Received transition is initiated, the Timecard application registration request is successful resulting in a state changed to Registered.

### State: Registered

The Timecard application is registered with the Timecard server and ready for use by the mobile device user, using the current locally stored application configuration information. When a New Configuration Message Received transition is initiated, a configuration message containing information about general application operation, incentives parameters, and related data is validated, stored locally and an acknowledgment message is sent. If the message is not validated, an error message is sent to the Timecard server. There is no resulting state change. When a User Start transition is initiated, the user indicates he/she is ready to begin operating mode with a user interface action. The resulting state is Unrestricted Mode. When an Uninstall Application transition is initiated, an unregister message is sent to Timecard server. The application is uninstalled, and all related data files are deleted from the mobile device.

### State: Unrestricted Mode

The Timecard application is running, but not in Restricted Mode and not earning any incentives configured for the application. The user interface indicates Unrestricted. The function Restricted Mode Disable is called to Unrestrict any restricted functions of the mobile device, if previously enabled. When the User Acknowledgment Enter Restricted Mode transition is initiated, the User acknowledges on the user interface to enter Restricted Mode and potentially earn incentives. The resulting state is Restricted Mode Unincentivized. When the User Stop transition is initiated, the user indicates he/she is ready to stop operating mode with a user interface action. The resulting state is Registered. When the uninstall Application transition is initiated, an unregister message is sent to the Timecard server. The application is uninstalled and all related data files are deleted from the mobile device.

### State: Restricted Mode Unincentivized

The Timecard Application sets the mobile device into Restricted Mode. The user is now eligible to earn incentives configured for the application, but is not currently earning incentives. The function Incentives Earning Disable is called to stop earning incentive rewards if previously enabled. The function Restricted Mode Enable is called to restrict any restricted functions of the mobile device, if the mobile device is not currently in the Restricted mode. When the Parameters Met transition is initiated and the parameters are met that indicate the mobile device is eligible to earn incentives, the resulting state is Restricted Mode Incentivized. When the User End transition is initiated, the user indicates he/she is ready to stop Restricted mode with a user interface action. The resulting state is Unrestricted Mode. When the event End transition is initiated and the configured time expires, the mobile device switches out of Restricted Mode. The resulting state is Unrestricted Mode.

### State: Restricted Mode Incentivized

The Timecard Application sets the mobile device into Restricted Mode. The user is now eligible and earning incentives configured for the application. The function Incentives Earning Enable is called to start or continue earning incentive rewards. The function Restricted Mode Enable is called to restrict any restricted functions of the mobile device, if the mobile device is not currently in the Restricted mode. When the Parameters Unmet transition is initiated, the one or more parameters that indicate the mobile device is eligible to earn incentives no longer evaluates true. The resulting state is Restricted Mode Unincentivized. When the User End transition is initiated, the user indicates he/she is ready to stop Restricted mode with a user interface action. The resulting state is Unrestricted Mode. When the Event End transition is initiated and the configured time expires, the mobile device switches out of Restricted Mode. The resulting state is Unrestricted Mode.

FIG. 2 illustrates an exemplary state diagram for a mobile device according to various embodiments.

### State 1: No User Entry

The user identity is unknown to the Timecard server application. The server will not respond to any requests from the Timecard Mobile Device Application associated with the user identity. When the Create User transition is initiated, a new user identity is created through a Timecard server management interface. The creation of a new user identity enables the associated user to use the Timecard Mobile Device Application. The resulting state is 2: User Entry. All other events have no change in state.

### State 2: User Entry

A user has been created in the Timecard server application. The Timecard server application will respond to requests from the Timecard Mobile Device Application. When the Registration Request transition is initiated, the Timecard server application receives a registration request message from the Timecard Mobile Device Application. If the user is authorized to earn incentives and use the Restricted mode, a registration request acknowledgement is sent and the resulting state is Registered User. If the user is not authorized to earn incentives and use the Restricted mode, a registration request denied is sent and the resulting state remains User Entry.

### State 3: Registered User

The Timecard Server Application is ready to respond to the Timecard Mobile Device Application user's request to enter Restricted mode and become eligible to earn incentives. When the User Restricted Start transition is initiated, the Timecard Mobile Device Application user has acknowledged on the mobile device user interface to enter Restricted mode and become eligible for earning incentives. A User Restricted Start event is received by the Timecard Server Application, resulting state is User Restricted Mode. When the Unregistration Request transition is initiated, the Timecard Mobile Device Application has sent a unregister request signaling that the user is no longer ready to enter Restricted mode and earn incentives. The resulting state is User Entry. When the Time Out transition is initiated and a time out occurs in the Registered User state, it indicates the user's mobile device is no longer reachable from the Timecard server. The resulting state is User Entry. When the Configuration Update Request transition is initiated, the Timecard Server Application sends a configuration update request to the Timecard Mobile Device upon any changes to the user configuration information from the Timecard Server Application management interface. The resulting state is Configuration Acknowledgement Pending. All other events have no change in state.

### State 4: Configuration Acknowledgment Pending

The Timecard Server Application waits for a configuration update acknowledgment from the Timecard Mobile Device Application. When the Configuration Update Acknowledgment transition is initiated, the configuration update acknowledgment is received by the Timecard Server Application. The resulting state is Registered User. When the Time Out (Not shown in FIG. 2) transition is initiated and a time out occurs before the configuration update acknowledgment is received, the configuration update request may be resent a configured number of times. Upon a final time out, the resulting state is User Entry.

### State 5: User Restricted Mode

The Timecard Server Application is ready to receive log entries from the Timecard Mobile Device Application recording durations when the user was in Restricted mode and earning incentives and durations when the user was in Restricted mode and not earning incentives. When a Receive Log Entry transition is initiated, the Timecard Server Application receives a log entry from the Timecard Mobile Device Application, resulting state is User Log Update. When a User End transition is initiated, the Timecard Mobile Device Application user has indicated they are no longer in Restricted mode and eligible for earning incentives. The resulting state is Registered User. When an Event End transition is initiated, the Event End is received from the Timecard Mobile Device Application, or generated locally upon the configured Restricted mode period expiration. The Timecard Mobile Device Application user is no longer in Restricted mode and eligible for earning incentives. The resulting state is Registered User.

### State 6: User Log Update

The incentive earnings and non-incentive earnings periods are logged by the Timecard Server Application for the Timecard Mobile Device Application user. The log may be used later to determine the rewards associated with the incentive periods and/or any penalties associated with the non-incentive periods. As a Default, after logging of the User Log Update is completed, the resulting state is User Restricted Mode.

### Exemplary Functions

### Function: Restricted Mode Enable

### Parameters: Configuration Data

### Returns: True=Success, False=Failure

Calls mobile device platform specific APIs to limit the mobile device applications and features of applications that are available to the user. Uses configuration data to identify applications that user is fully blocked from using. Uses configuration data to identify applications that user is partially blocked from using specific features. Uses configuration data to identify applications that user is fully allowed to use. Uses configuration data to specify that all other applications not explicitly listed above are either fully allowed or fully blocked. Returns true if all APIs return successfully for processing the configuration data. If any API returns an error, resets all applications to unblocked mode and returns false.

### Function: Restricted Mode Disable

### Parameters: None

Returns: True=Success. False=Failure

Calls mobile device specific APIs to eliminate any application or feature blocks set by previous calls to Restricted Mode Enable. Returns true if all API calls succeed. If any API calls return an error, continues call all other API calls, and returns false on completion of all remaining calls.

### Function: Incentive Earnings Enable

### Parameters: Configuration Data

### Returns: True=Success, False=Failure

Sets earning enabled flag. Sets earnings period timer from configuration data. Enables earnings increment on periodic timer expiration, and automatic timer reset. Returns false if failure to set period timer. Returns true otherwise

### Function: Incentive Earnings Disable

### Parameters: None

### Returns: True

Resets earning enabled flag. Disables earnings increment periodic timer. Returns true.

### Function: Configuration Data Store

### Parameters: Configuration Data

### Returns: True

Timecard Mobile Device Application stores new configuration data received from Timecard Server Application.

There are a wide variety of uses for the Timecard Application, for example, Geo-fenced operation; Time-based operation; Time-duration operation; Incentive acceleration operation; Restricted untouched operation; Incentive opportunities operation; Limited use operation; emergency operation; or the like. These uses may be combined in various permutations to address specific needs.

Geo-fencing refers to specifying one or more geographic areas that are configured for the Timecard application operation. The geo-fencing information is received as configuration information from the Timecard server and stored on the Mobile Device. The geo-fencing configuration information is used to determine the operational state when the state has transitioned to at least the “Unrestricted Mode”. For example, when the mobile device is within one of the designated restricted and incentivized geo-fenced regions, the device operates in a Restricted whereMode Incentivized, and the user earns incentives during the defined operational period. When the mobile device is within one of the designated restricted and incentivized geo-fenced regions, the device operates in Restricted Mode Unincentivized, and the user does not earn incentives, outside the defined operational period. When the mobile device is within one of the designated restricted but unincentivized geo-fenced regions, the device operates in Restricted Mode Unincentivized, and the user the user does not earn incentives. When the mobile device is not within one of the designated restricted geo-fenced regions, the device operates in Unrestricted Mode. To enable Unrestricted, Restricted Unincentivized and Restricted Incentivized operation, geo-fencing configuration may include the parameter pairings: Unrestricted and Restricted; and Unincentivized and Incentivized. The pairing Unrestricted and Incentivized may not be applicable.

Time-based operation refers to specifying a period of time (i.e., “wall clock” time) when the incentive based on use of the Timecard application is available. The time period may be a single instance, a regularly repeating instance, or some other schedule defined by the Timecard server. The time period configuration information may be sent by the Timecard server, and received and stored on the Mobile Device. The time period configuration information may be used to determine the operational state. When the current time is within a time period, the mobile device may transition to any of the operational states. The operational states may be limited by any other configuration information and current operating parameters. When there exists no such limiting configuration information and current operating parameters, the timecard application may transition to the Restricted Incentivized mode throughout the duration that the current time is within the configuration time period. When the current time is not within a time period, the mobile device may transition up to the Registered state, but may not enter the Unrestricted, Restricted Unincentivized, or Restricted Incentivized states. In some embodiments, the Timecard application is dormant on the mobile device when not in a configuration time period.

Time-duration operation refers to specifying an available amount of time that may be accumulated in the Restricted Unincentivized and Restricted Incentivized states. The time-duration may be treated as a time bank account that can have debits and credits to the amount available. The time period configuration information may be sent by the Timecard server, and received and stored on the Mobile Device. The time-duration configuration information is used to determine the operational state. While there is time remaining in the account the mobile device can be put in to the Unrestricted, Restricted Unincentivized and Restricted Incentivized states. When there is no time remaining in the account the mobile device may only reach the Registered state.

Incentive acceleration operation refers to algorithmically increasing the rate of incentives earned during the Restricted Incentivized state. Such rate may be accelerated based on timecard server configuration. The incentive acceleration configuration may be sent by the timecard server, and received and stored on the Mobile Device. The incentive acceleration configuration is used to determine the operational state. While the mobile device is in the Restricted Incentivized state, the rate of incentive earning is increased depending on operational parameters such as the length of time spent continuously in the Restricted Incentivized state.

Restricted untouched operation refers to operation when the mobile device is stored stationary during operation, such as place on a shelf, with no further interaction with a user during this operating period. Various mobile device sensors may be employed to determine that the mobile device is stationary and unused during the operating period. The restricted untouched configuration is used to determine whether the mobile device is untouched. The restricted untouched configuration information may be sent by the timecard server, and received and stored on the Mobile Device. The restricted untouched configuration is used to determine the operational state. When it is determined that the mobile device is operating untouched based on the operational parameters matching the restricted untouched configuration, the mobile device may be in the Restricted Incentivized data. When the operational parameters do not match the restricted untouched configuration information, the mobile device may be in the Restricted Unincentivized data.

Incentive opportunities operation refers to earning one or more choices of types incentives available to the Timecard application user. The incentive opportunities configuration is received from the Timecard server and stored on the Mobile Device. The incentive opportunities configuration is used to determine the operational state. While the mobile device is in Restricted Incentivized state, the user earns one or more incentive units from one or more incentive types per the incentive opportunities configuration and the operating parameters. While the mobile device is not in Restricted Incentivized state, the incentive opportunities configuration is not used.

Limited use operation refers to operation of the mobile device where a subset of approved applications other than the timecard application are enabled during the Restricted Unincentivized and Restricted Incentivized states. The limited use configuration information is received from the Timecard server and stored on the Mobile Device. The limited use configuration information is used to determine the operational state. When one of the approved applications is in use, the mobile device may be in the Restricted Unincentivized or the Restricted Incentivized state. In the case of the Restricted Incentivized state, the user continues to earn incentive units while using one of the approved applications.

Emergency operation refers to any instance where the mobile device must be used outside of the Timecard application. Such emergency operation immediately transitions the mobile device to at most, the Registered state.

Although the subject matter has been described in language specific to structural features and/or methodological acts, it is to be understood that the subject matter in the appended claims is not necessarily limited to the specific features or acts described above. Rather, the specific features and acts described above are disclosed as example forms of implementing the claims. Other configurations of the described embodiments are part of the scope of this disclosure. Further, implementations consistent with the subject matter of this disclosure may have more or fewer acts than as described or may implement acts in a different order than as shown. Accordingly, the appended claims and their legal equivalents should only define the invention, rather than any specific examples given.

We claim as our invention:

1. A method for incentivizing a user, the method comprising:
registering a mobile device of a user with a server;
clocking-in, with an application on the mobile device, the user at the server;
limiting a functionality of the mobile device with the application; and
incentivizing the user with a benefit while the limiting of the functionality of the mobile device is in effect.

2. The method of claim 1, wherein the application comprises a timecard application and the server comprises a timecard server.

3. The method of claim 1, further comprising stopping the incentivizing when the limiting of the functionality of the mobile device is not in effect.

4. The method of claim 1, further comprising triggering the incentivizing based on the mobile device entering a geo-fenced area; and stopping the incentivizing when the mobile device leaves the geo-fenced area.

5. The method of claim 4, further comprising triggering the limiting based on a time of day.

6. The method of claim 1, wherein the benefit comprises changing an hourly rate of the user.

7. The method of claim 1, wherein the benefit comprises a monetary reward for the user.

8. The method of claim 1, wherein the benefit comprises accelerating a rate of the benefit based on a duration of the limiting.

9. The method of claim 1, further comprising interacting with the user using a user interface prior to the limiting.

10. The method of claim 1, further comprising receiving a configuration from the server.

11. The method of claim 1, further comprising receiving a configuration comprising a user application name, wherein the limiting of the functionality is selected from one or more of fully blocking execution of the user application name, partially blocking execution of the user application name, allowing execution of the user application name, allowing execution of applications on the mobile device other than the user application name, or blocking execution of applications on the mobile device other than the user application name.

12. The method of claim 1, further comprising receiving a configuration comprising a mobile device feature, wherein the limiting of the functionality is selected from one or more of fully blocking use of the mobile device feature, partially blocking use of the mobile device feature, allowing use of the mobile device feature, allowing use of mobile device features on the mobile device other than the mobile device feature, or blocking use of the mobile device features on the mobile device other than the mobile device feature. A system to incentivize a user, the system comprising:
a server to registering a mobile device of a user;
an application on the mobile device to clock-in the user at the server and to limit a functionality of the mobile device with the application,
wherein the user is incentivized with a benefit while the application limits the functionality of the mobile device.

14. The system of claim 13, wherein the application comprises a timecard application.

15. The system of claim 13, wherein the incentivizing of the user is stopped when the application does not limit of the functionality of the mobile device.

16. The system of claim 13, wherein the application starts the incentivizing based on the mobile device entering a geo-fenced area, and stops the incentivizing when the mobile device leaves the geo-fenced area.

17. The system of claim 13, wherein the application starts the incentivizing based on a time of day.

18. The system of claim 13, wherein the benefit comprises changing an hourly rate of the user.

19. The system of claim 13, wherein the benefit comprises a monetary reward for the user.

20. The system of claim 13, wherein the application interacts with the user using a user interface prior to the limiting.
